(19) United States
(12) Patent Application Publication
(10) Pub. No.: US 2025/0116506 A1
(43) Pub. Date: Apr. 10, 2025

(54) SYSTEM AND METHOD FOR CONFOCAL-CHROMATIC LINE DISTANCE MEASUREMENT

(71) Applicant: MICRO-EPSILLON OPTRONIC GMBH, Dresden-Langebrück (DE)

(72) Inventors: Tobias OTTO, Dresden (DE); Christoph GRÜBER, Dresden (DE); Torsten STAUTMEISTER, Dresden-Langebrück (DE)

(73) Assignee: MICRO-EPSILON OPTRONIC GMBH, Dresden-Langebrück (DE)

(21) Appl. No.: 18/834,356

(22) PCT Filed: Dec. 22, 2022
(86) PCT No.: PCT/DE2022/200314

§ 371 Date: Jul. 30, 2024

(30) Foreign Application Priority Data
Feb. 11, 2022 (DE) 10 2022 201 419.7
Mar. 22, 2022 (DE) 10 2022 202 778.7

(51) Int. Cl. G01B 11/06; G01J 3/02; G01J 3/10; G01J 3/28

(52) U.S. Cl. CPC G01B 11/0608; G01J 3/0208; G01J 3/021; G01J 3/10; G01J 3/2823; G01B 2210/50

(57) ABSTRACT

A system for confocal-chromatic line distance measurement, comprising a line light source (2), an aperture (3), a confocal-chromatic, preferably rotationally symmetrical, measurement lens (6), and a spectrometer (14), preferably a 2D spectrometer, wherein the illumination beam path extends from the light source (2) via the aperture (3) and a first region (5) of the measurement lens (6) to the measurement object (9) and wherein the imaging beam path extends from the measurement object (6) via a second region (11) of the measurement lens (6) to the spectrometer (14). Furthermore, a method for confocal-chromatic line distance measurement is specified.

The invention relates to a system for confocal-chromatic line distance measurement, with a line light source, an aperture, a confocal-chromatic measurement lens, and a spectrometer.

Furthermore, the invention relates to a method for confocal-chromatic line distance measurement.

Systems and methods for confocal-chromatic point distance measurement have been known in the industry for years. These are characterized by an extremely high distance resolution, whereby the measuring point diameter is in the range of a few micrometers (3 to 30 μm). This enables particularly high lateral and distal resolutions in the scanning process, which are superior to point triangulators due to measuring spot diameters that are up to 10 times larger. Further advantages of confocal chromatic distance sensors are the lower speckling and their lower influence compared to laser light sources. In addition, a significantly higher depth resolution is possible for thickness measurements on thin layers and the small sensor size in the area of the measurement object means that there is less potential for collision between the sensor and the measurement object.

Furthermore, systems for confocal line distance measurement are already known. These can essentially be divided into two approaches. One approach is to project and measure a line concentrically through a confocal chromatic lens and the other is to use the principle of confocal chromatic theta microscopy.

The first approach basically has the advantage of a compact design and easier usability due to a spherical, only slightly restricted working space around the measuring range. It is also possible for the user to change the lens.

The second approach features a significantly better depth resolution (z) and better lateral resolution (x), but with the limitation of a complex and space-filling setup, as well as a complex adjustment during sensor production.

While in one-dimensional, confocal chromatic distance determination the chromatically coded focal point array lies on the lens axis, this principle only works with severe limitations when projecting and imaging a chromatically coded line array that lies in a plane with the lens axis. This is due to the fact that, due to the real expansion of the illumination and viewing foci, closely neighboring measurement locations always cause crosstalk in the neighboring channel, as the corresponding transmit and receive beams overlap very strongly, especially in the z-direction.

In the document U.S. Pat. No. 10,725,178 A1, therefore, no continuous line is projected and observed, but instead a chain of individual measuring points is used for projection and detection by means of a fiber array. Individual measuring points are so far apart that the effect of crosstalk between individual channels becomes negligible.

Confocal chromatic theta microscopy offers the advantage that the depth of field of the illumination and viewing foci can be significantly reduced with a considerably larger effective aperture, without losing a disproportionate amount of measuring range in the z-direction. EP 2 901 102 discloses that a confocal chromatic illumination optic spans a multispectral line to form a spectrally coded line array, which is positioned at an angle of theta (Θ) to the optical axis of the lens and forms the measuring plane. A second optical system is positioned at a negative angle theta (—Θ) to the measuring plane and images it onto an area detector conforming to the Scheimpflug principle. In order to evaluate the color coding on the sensor representing the measuring height, a color gradient filter takes over the function of a spectral aperture.

The present invention is based on the task of designing and further developing a system and a method for confocal chromatic line distance measurement in such a way that synchronous measurement along the entire lines with high depth resolution is possible with low space requirements and high measuring speed.

With regard to the system, the problem is solved by the features of claim 1. A system for confocal-chromatic line distance measurement is thus specified, with a line light source, an aperture, a confocal-chromatic, preferably rotationally symmetrical, measurement lens, and a spectrometer, preferably a 2D spectrometer, wherein the illumination beam path runs from the light source via the aperture and a first region of the measurement lens to the object to be measured and wherein the imaging beam path runs from the object to be measured via a second region of the measurement lens to the spectrometer. It should be noted that the term “rotationally symmetrical” also includes embodiments in which the lens or lenses have an angular trim, but are arranged or designed to be rotationally symmetrical in the broadest sense.

With regard to the method, the problem is solved by the adjacent claim 20. A method for confocal-chromatic line distance measurement is thus given, preferably using a system according to one of claims 1 to 19, wherein illumination light is directed from a line light source via an aperture and a first region of a confocal-chromatic measurement lens as a color-coded illumination plane onto a measurement object, wherein spectrally coded measuring light is guided from the measurement object via a second region of the measurement lens to a spectrometer, preferably a 2D spectrometer, and wherein a spectrometric analysis of the measuring light is performed to determine the distance.

In accordance with the invention, it has been recognized that the underlying task can be solved by a confocal chromatic hyperspectral line spacing measurement system which follows the principle for resolution enhancement of confocal theta microscopy. For example, a continuous white light line can be projected onto a measurement object whose height contour is reflected in a color coding of the z-distance to the measurement lens. Based on a spectrometric, hyperspectral analysis of this measurement line, a synchronous, locally continuous, high distance resolution can be achieved along the entire line. A corresponding analysis can be carried out in an evaluation unit set up for this purpose, e.g., on a computer.

In a system with a line light source, an aperture, a confocal-chromatic measurement lens, and a spectrometer, a first area of the measurement lens, for example one half of the measurement lens, is used to illuminate the measuring point with a spectrally coded line array and another, second area of the measurement lens, for example the other half of the measurement lens, is used to image the spectrally coded height profile reflected by the measuring object. This means that the illumination and imaging paths are separated from each other and thus fulfill the approach of confocal-chromatic theta microscopy in just one measurement lens. Furthermore, the measurement lens serves both as an illumination optic and as an imaging optic. The aperture can be designed as a separate component or as part of the line light source. Furthermore, the aperture can be a slotted aperture, for example.

In detail, the line light source can initially be located on the entrance side in the focal point of the confocal-chromatic measurement lens. Alternatively or additionally, an entrance aperture of the spectrometer can be located on the exit side in the focal point of the confocal-chromatic measurement lens. In order to divide the measurement lens into two areas or two functional halves, the measurement lens can be blinded, for example using a directional aperture, so that the light is not symmetrically distributed in the measurement lens, but only in the first area of the measurement lens. As a result of this measure according to the invention, the measuring light passes through only one side of the measuring objective and the multispectral line coming from only one side of the measuring objective is fanned out to form a group of curves which can lie as a plane in the optical axis of the measuring objective. If a measurement object lies in this plane, a height profile is created whose distance to the measurement lens is reflected by the color focused at this distance. The chromatic height-coded profile line created on the measurement object is reflected back to the location of the line light source by the second area of the measurement lens.

In a further way according to the invention, the different course of the illumination beam path and imaging beam path avoids the disadvantage that occurs with identical optical paths, namely that the overlapping of transmit and receive beams leads to lateral crosstalk between adjacent measuring locations. In this way, signal-degrading “crosstalk” is avoided without having to resort to the equally disadvantageous solution of the illumination point array, which in turn leads to lateral measurement gaps. As a result, a fast two-dimensional, continuous line measurement with a high depth of field is possible with the gauge according to the invention. Another advantage lies in the spectrometric evaluation of the color-coded height profile. Since in the state of the art the profile is evaluated in a triangulation process with spectral filtering, a color gradient filter must be arranged in front of the matrix, which has the same wavelength curve as that of the spanned plane and thus fulfills the function of a color gradient aperture. This creates a kind of “autofocusing”. However, inaccuracies in this filter mean that the focal plane spanned by the first confocal-chromatic lens does not match the detection plane exactly, resulting in accuracy errors. These problems do not occur when using a spectrometer.

Since the line of the measured light is evaluated by a spectrometer, preferably a 2D spectrometer, in which this line is spectrally decomposed on a matrix, the color-coded height profile is only evaluated after the spectral decomposition, for example by a CMOS area detector. The sensor-specific, insensitive areas between the individual pixels can be compensated for by micro-lens arrays, for example. This means that it is the matrix in the spectrometer that determines the quantization noise, as the signal was passed on in analog form up to the matrix.

Furthermore, it has been recognized that the concentric lens arrangement of the measurement lens offers the advantage that it can be manufactured much more easily. In addition, this type of measurement lens has the advantage that the form factor provides more free space around the lens. A further advantage lies in the possibility of varying the measuring range and thus also the resolution of the measuring system by simply changing the measurement lens. This is due to the fact that the measurement lens both creates a measuring plane from a multispectral line and merges this plane back into a color-coded line. The location of the image and the image scale in relation to the line light source remain independent of the measurement lens. The width and height of the measuring plane projected by the measurement lens and thus the resolution is therefore independent of the rest of the measuring system. Furthermore, the system according to the invention is extremely small, since both a crossed measurement lens arrangement and a multi-fiber arrangement, which are necessary in known systems, can be dispensed with. Even if the measurement lens diameters can be smaller in a crossed measurement lens arrangement in order to achieve the same depth resolution, these must have similar measurement lens diameters to the system according to the invention in order to achieve a comparable tilting characteristic. The tilt characteristic here refers to the angle at which the surface normal of the measurement object may be positioned in relation to the measurement system axis so that the measuring light still has a sufficiently good signal-to-noise ratio. This quality criterion is crucial for measuring curved surfaces.

According to an advantageous configuration, the measurement lens and an entrance aperture of the spectrometer and possibly other parts of the system (conversion optics) can lie on a common virtual (imaginary) optical axis.

Advantageously, the measurement lens can have exactly one single lens. This can be a field-corrected lens, for example a pressed double-spherical lens, or a double-aspherical lens. Alternatively, it is conceivable that the measurement lens has at least two optical lenses. The lenses can be arranged concentrically to each other. This results in a particularly simple design of the measurement lens, which is characterized by a small installation space.

In an advantageous way, a single confocal-chromatic measurement lens can be arranged. The use of only a single measurement lens, whose measuring plane is also in the optical axis, has the advantage over a system with several measurement lenses that the free space around the measuring point is considerably larger and spherical at the same time. This means that the system can be used more flexibly for automated measurements. This principle also allows the measurement lens to be immersed in holes, which opens up significantly more areas of application for this system than, for example, a system with several measurement lenses. Furthermore, a design with only a single measurement lens has the advantage that thermal effects are reflected both in the illumination and in the measuring light. Due to the symmetrical design, thermal effects on the measuring system are more homogeneous and therefore more correctable than in arrangements with several measurement lenses. With these, the illumination and measuring plane can drift far further apart and are therefore more susceptible to thermal changes. Another advantage of using a single measurement lens compared to the arrangement of several measurement lenses is the irrelevance of focal length tolerances. Manufacturing tolerances of the measurement lenses or in the adjustment lead directly to quality losses when using two measurement lenses, as the illumination plane spanned by the first measurement lens does not lie exactly on top of the measuring plane captured by the second measurement lens. It is also problematic to keep the spectral focus positions together over the entire distance range.

Compared to a system with two separate measurement lenses, which are crossed to each other and have a finite approximability, a particularly high lateral resolution with high light intensity can be achieved by using a single measurement lens with very small measuring ranges.

In a further advantageous way, the optical axis of the measurement lens can coincide with the distance axis of the system. This has the advantage that the system requires little installation space and the measuring plane is in a position that is obvious to the user.

According to a further advantageous configuration, the line light source can emit a continuous white light line. The separate arrangement of the illumination and imaging path according to the invention makes it possible to use a continuous line source. This is not possible with an identical optical light path due to the aforementioned overlapping of the transmit and receive beams. By using a continuous white light line, a high lateral resolution and depth resolution can be achieved.

In a particularly advantageous way, the line light source can emit two or more, preferably continuous, illumination lines. Alternatively or additionally, two or more line light sources can be arranged, each of which emits at least one, preferably continuous, illumination line as illumination light. In this configuration, two or more lines, preferably parallel to each other, are projected and evaluated. In one embodiment, the illumination light for the various illumination lines can originate from a common light source and simultaneously emerge through several apertures, or from separate, individually controllable light sources or from a common light source with several apertures that can be individually shaded. The apertures of the light sources are preferably located in the vicinity of the virtual optical axis, whereby the vicinity, if necessary, could be defined, for example, as the distance of half a profile length from the virtual optical axis. As described in the following embodiments, a single spectrometer can be arranged, preferably a 2D spectrometer, for example a Dyson spectrometer. The entrance aperture of the spectrometer can have as many entrance apertures as there are illumination lines. The position of the entrance apertures and their distances can correspond to those of the light source(s), whereby any scaling caused by the converter optic must be taken into account.

In an advantageous way, the line light source can be arranged on the entrance side in the focal point of the measurement lens, so that a simple beam path is realized and the precise acquisition of measured values is made possible.

In a further advantageous way, a deflection element can be arranged in the illumination beam path and/or in the imaging beam path. The deflection element can thus deflect the illumination light and/or the measuring light, since the linear light source and the image are in the same spatial position in the device according to the invention. The deflection element can always be located in the illumination or imaging path. Specifically, it is conceivable that a deflection element is arranged in the illumination beam path between the aperture and the measurement lens and/or that a deflection element is arranged in the imaging beam path between the measurement lens and the spectrometer. A particularly compact design can be achieved by arranging a deflection element in both the illumination beam path and the imaging beam path. It is also conceivable that the deflection element serves as a directional aperture and blocks the illumination light in such a way that the illumination light only hits the measurement lens in the first area. The directional aperture can also be realized as a component separate from the deflection element. It is essential that the one glare in the beam path defines the solid angle ranges into which the light is emitted and thus also the zone which is illuminated by the chromatic optic.

In a particularly advantageous way, the deflection element can be designed as a mirror or as a beam splitter. The advantage of a mirror is that it only leads to power losses in the range of 0% to 3%. The use of a beam splitter is also conceivable, although this leads to power losses of at least 75%.

According to a further advantageous design, a converter optic can be arranged. Since the expansion of the line source can be relatively large in order to achieve a sufficient amount of light and at the same time a technically and economically efficient area scan camera is considerably smaller, this disproportion can be compensated for by a converter optic. In principle, this adjusts the length of the aperture or illumination slit to the length of the spectrometer's entrance aperture. The position of the converter optic can be advantageously located between the measurement lens and the spectrometer, as this is where the greatest benefit is achieved with the least effort. Another possible position for the converter optic is between the light source and the measurement lens, so that the illumination falls into the lens at a reduced size. In other words, the converter optic is an adapter for adapting technically available components for the linear light source and the spectrometer.

In an advantageous manner, the converter optic can have at least one optical lens, whereby the at least one optical lens is arranged concentrically to the measurement lens in a basic optical model or lies on a common virtual (imaginary) optical axis with the measurement lens and possibly other components (aperture, entrance slit of the spectrometer). The concentric arrangement allows an optimized optical design for all field points without requiring a more or less ideally collimated beam section.

It is also conceivable that the spectrometer or 2D spectrometer is a Dyson spectrometer. For a high measurement rate, it is essential to provide the detector element with sufficient photons. Going through the signal chain from back to front, the detector must have a high quantum efficiency. The choice using of a Dyson spectrometer for analyzing the reflected measuring light has the additional advantage that the evaluating area detector is irradiated almost vertically and not at a high angle, as is necessary with the triangulation method due to the Scheimpflug principle. In this way, the highest possible quantum efficiency of this essential component is utilized, with positive effects for the entire signal processing. A Dyson spectrometer allows a large entrance NA (numerical aperture), which is linked to the observation NA on the measurement object via the imaging scales. This should be as large as possible for large tilt angles on the measurement object. Specifically, the spectrometer can have an entrance aperture, in particular a slit-shaped one, an optical lens, in particular a Dyson lens, a line grid, in particular a concave one, and an area detector. Such a design is characterized by a simple structure and high measuring accuracy.

In a further advantageous way, the line grid can be provided with a blaze structure and/or have equidistant, parallel structures. A blaze structure has the advantage that improved efficiency is achieved in the diffraction order used. Alternatively or additionally, the entrance aperture can have a width of less than or equal to 20 μm, preferably less than or equal to 10 μm. This has the advantage that an ideal spectral resolution is achieved in relation to the pixel resolution of the area detector.

In a particularly advantageous way, the illumination beam path and the imaging beam path between the measurement lens and the object to be measured can each run at an angle of between 30° and 160°, in particular from 60° to 120°, preferably from 85° to 95°, and ideally from 90°. This has the advantage that the greatest possible spatial resolution is achieved. By mounting the measuring plane laterally, a significantly higher depth resolution can be achieved than with concentric object illumination, in which the illumination and imaging paths are not separate. The reason for this is the significantly larger effective numerical aperture (NA). The depth resolution, i.e., the distinction between two closely spaced points or planes in the z-direction, is also noticeably improved. An angle of 90° between the measuring and imaging beam path results in an ideal image, whereby a smaller angle can reduce shadowing effects on steps.

Furthermore, it should be noted that the features of the system according to the invention discussed above can also have a procedural embodiment. A combination of these features with the features relating to the method claim is not only possible, but advantageous.

There are now various possibilities for advantageously designing and further developing the method of the present invention. Reference should be made, on the one hand, to the claims following claim 1 and, on the other hand, to the following explanation of preferred embodiments of the invention with reference to the drawing. In connection with the explanation of the preferred embodiments of the invention with reference to the drawing, generally preferred embodiments, and further embodiments of the method are also explained. The drawing shows

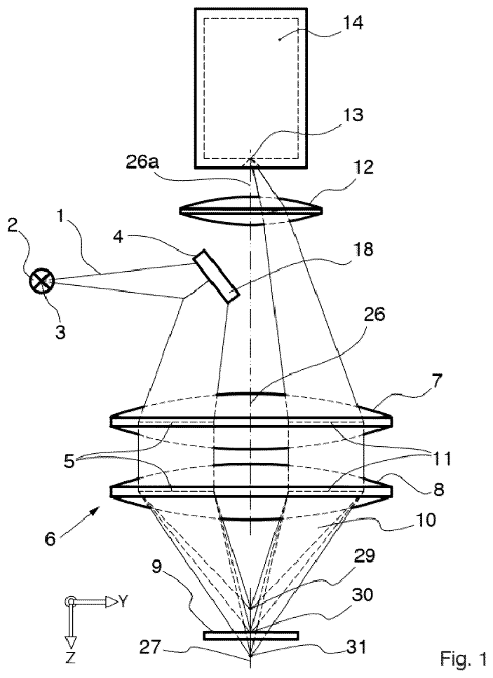

FIG. 1 in a schematic view an embodiment example of a system according to the invention, whereby the method according to the invention can also be discussed,

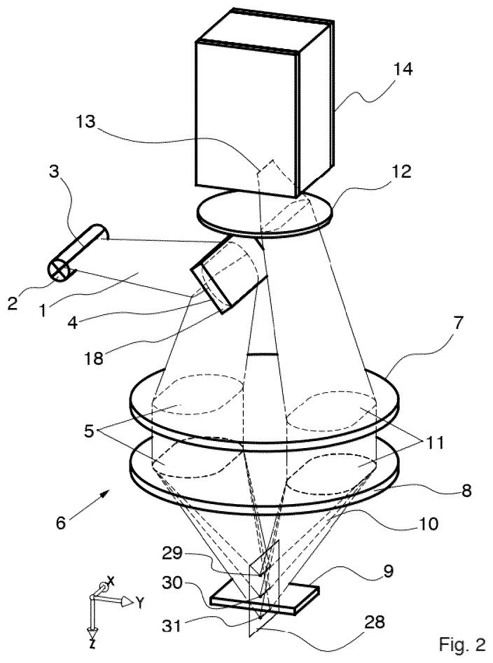

FIG. 2 in a schematic, dimetric view the embodiment example according to FIG. 1,

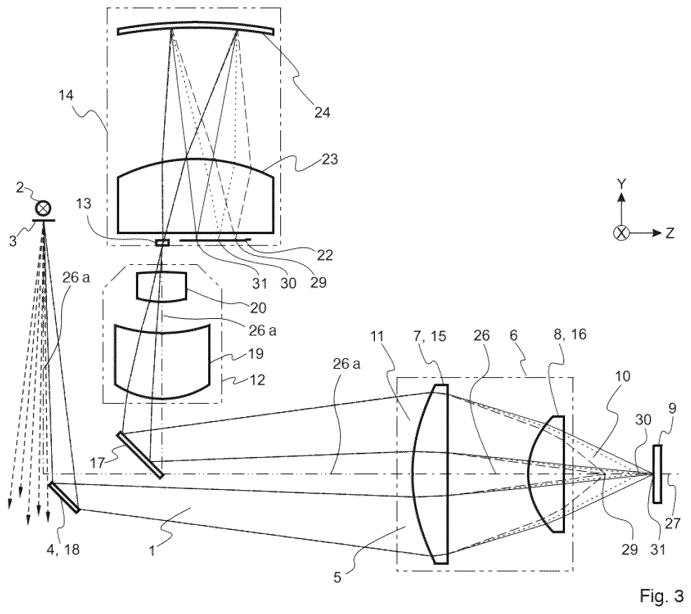

FIG. 3 in a schematic view a further embodiment example of a system according to the invention, whereby the method according to the invention can also be discussed,

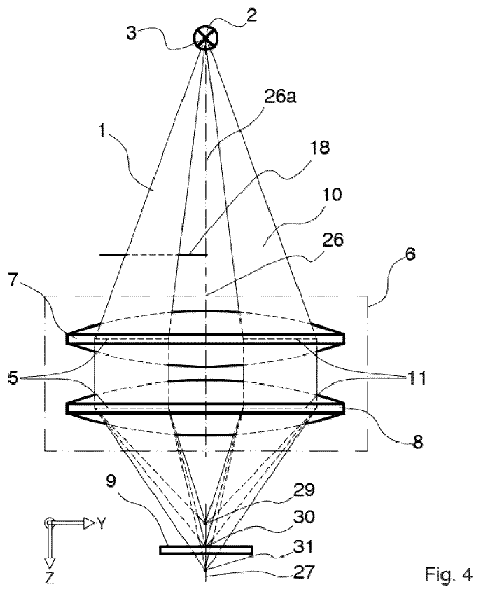

FIG. 4 schematic view of the theoretical beam model on which the method according to the invention is based,

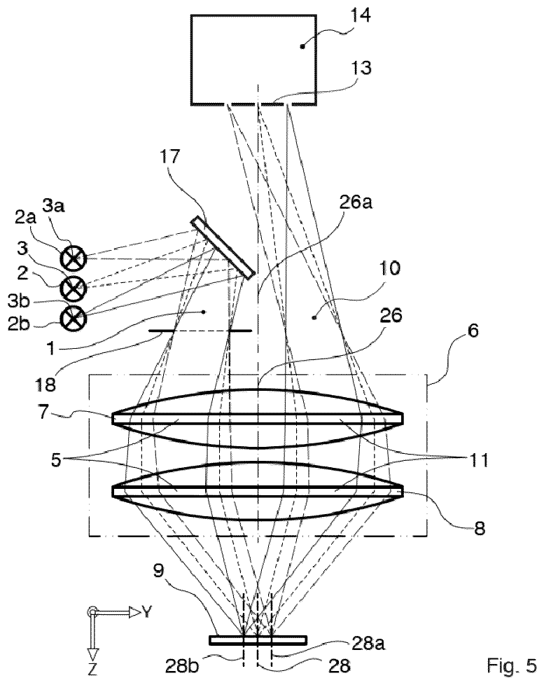

FIG. 5 in a schematic view a further embodiment example of a system according to the invention, whereby the method according to the invention can also be discussed,

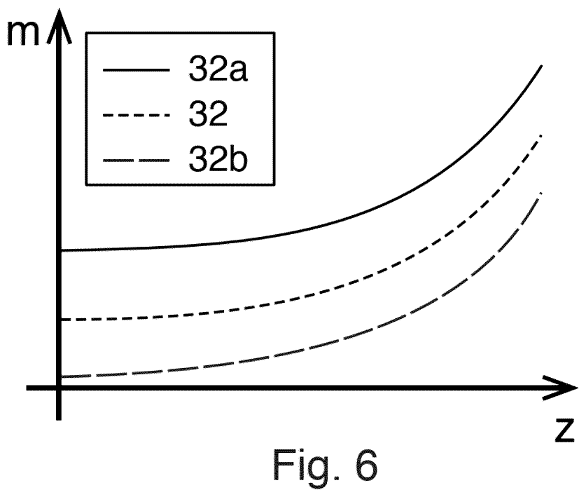

FIG. 6 for three different measuring planes, the line position m is plotted over the measuring distance z,

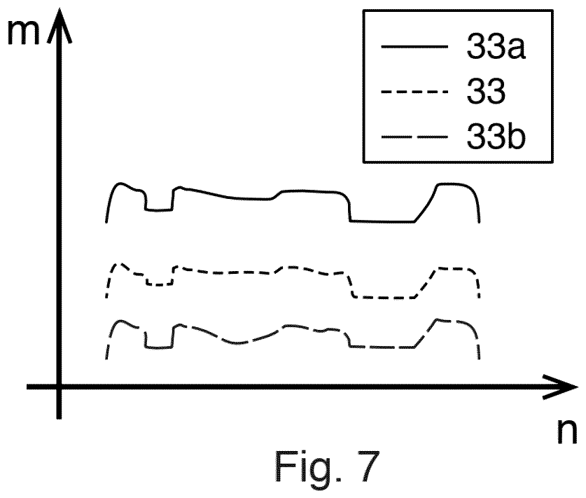

FIG. 7 an example of the profile of a target imaged by an area detector, which is recorded in the measuring plane, and

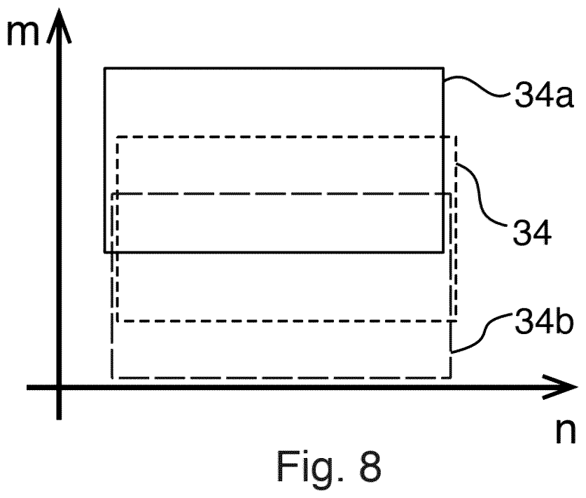

FIG. 8 an exemplary illustration of three spectral ranges, the lines m of the area detector being plotted over the columns n of the area detector.

FIGS. 1 and 2 show a first example of a system for confocal-chromatic line distance measurement according to the invention. In this, illumination light 1, preferably white light, is emitted from a line light source 2 with an aperture 3, for example a slit aperture. The illumination light 1 is directed by a deflection element 4 onto a first area 5 of a confocal-chromatic measurement lens 6. In this embodiment example, the measurement lens 6 has two optical lenses 7, 8, which are arranged concentrically to each other. The illumination light 1 falls on the measurement object 9 from the measurement lens 6. This makes it clear that the illumination beam path defined by the illumination light 1 runs exclusively through the first area 5 of the measurement lens 6.

The measuring light 10 reflected by the measurement object 9, which carries the spectrally coded height profile, only passes through a second area 11 of the measurement lens 6. A converter optic 12 is used to reduce the length of the measuring light 10 to the length of the entrance aperture 13 of the spectrometer 14. A distance measurement is carried out on the basis of a spectrometric, hyperspectral analysis of this measurement line. The imaging beam path defined by the measuring light 10 thus runs separately from the illumination beam path in the method according to the invention. The deflection element 4 also serves as a directional aperture 18 and ensures that only the first area 5 of the measurement lens 6 is illuminated and no stray light affects the second area 11.

Furthermore, FIG. 2 shows the measuring plane 28, in which the focal points for the different wavelengths 29, 30, 31 of the measuring light 10 are located.

FIG. 3 shows a further example of a system for confocal-chromatic line distance measurement according to the invention. This has a line light source 2 and an aperture 3, which is used to generate a light band in the x-direction. The half aperture of the illumination light 1 is directed exclusively onto a first area 5 of a confocal-chromatic measurement lens 6 via a deflection element 4 in the form of a mirror and then falls onto the measuring object 9. The measurement lens 9 has two concentrically arranged aspherical lenses 15, 16 and serves both as illumination optic and as imaging optic. However, these do not necessarily have to be aspherical lenses; other useful lens types can also be arranged.

The measuring light 10 reflected by the measurement object 9 passes exclusively through the second area 11 of the measurement lens 9 and is fed to the converter optic 12 by the further deflection element 17, which is also designed as a mirror. The converter optic 12 has two optical lenses 19, 20 and, compared to the aperture 3, provides a size-adjusted back-imaging onto the slit-shaped entrance aperture 13 of the spectrometer 14. In this example, the spectrometer 14 is designed as a 2D Dyson spectrometer and has a Dyson lens 23 and a concave line grid 24 in addition to the entrance aperture 13. It should be noted that the spectrometer 14 can also have a structure other than that shown. In this embodiment, the illumination beam path and the imaging beam path are therefore also separated from each other, with only a single measurement lens 6 being provided. Furthermore, it can be seen that in this embodiment example, as in the embodiment example according to FIGS. 1 and 2, the optical axis 26 of the measurement lens 6 coincides with the distance axis 27. Furthermore, FIGS. 1 to 3 clearly show that the aperture 3, the measurement lens 6, the converter optics 12, and the entrance aperture 13 are located on a common virtual (imaginary) optical axis 26a.

The embodiments described above each show a measurement lens 6 with two lenses 15, 16. However, this is not absolutely necessary. The measurement lens 6 could also have just a single lens or more than two lenses.

FIG. 4 shows a schematic view of the theoretical beam model on which the method according to the invention is based. This clearly shows that the line light source 2 and the entrance aperture 13 of the spectrometer 14 are located at exactly the same spatial position and on the common virtual optical axis 26a.

FIG. 5 shows an embodiment of a system according to the invention, which essentially corresponds to the system shown in FIG. 1. The main difference is that three individual light sources (2, 2a, 2b) are arranged with respective apertures (3, 3a, 3b). The lines of illumination could also be generated by a single light source with a multiple aperture, for example a multiple slit aperture, or by individual floodlights.

The, preferably parallel, offset of the line light sources (2, 2a, 2b) results in the clamping of three adjacent measuring planes (28, 28a, 28b). Furthermore, the spectrometer (14) has a multiple slit aperture (13) corresponding to the number of exit apertures (3, 3a, 3b) or the number of illumination lines. Furthermore, reference is made to the description of the preceding embodiments, which applies analogously to the system shown in FIG. 5.

FIG. 6 shows that each measuring plane (28, 28a, 28b) results in an assignment (32, 32a, 32b) of the measuring distance (z) to the line position m on the matrix. However, this simplified representation only refers to a discrete measurement location on the x-axis, which is shifted in the z-direction. The x-axis must still be taken into account for a complete mapping of this allocation.

FIG. 7 is an exemplary illustration of the profile of a target (9) imaged on an area detector (22), which is recorded in three measuring planes (28, 28a, 28b).

Furthermore, FIG. 8 shows an exemplary illustration of three spectral ranges (34, 34a, 34b), in each of which the measurement signal of the associated measurement plane moves with a discrete y-position. It becomes clear that the spectra of the adjacent entrance apertures are imaged in different areas of the area detector due to different angles of incidence on the grating. The resulting overlap of the spectral ranges (34, 34a, 34b) makes it clear that a monochrome area detector can lead to assignment problems, as the color information relevant for unambiguous assignment is lost.

However, differentiation would be possible if a polychromatic or hyperspectral area detector were used instead of a monochromatic detector.

Looking at the spectral image of each entrance aperture over its entire spectrum (see FIG. 8), it can be seen that, due to the different angle of incidence on the line grid, each entrance aperture produces an individual spectrum image on the spectrometer. In addition, these spectral ranges overlap to a large extent, so that an evaluation preferably fulfills the following boundary conditions:
1. Use of a polychromatic or hyperspectral area detector in the spectrometer in order to define the corresponding entrance aperture and thus also the measuring plane (y-position) at any measuring point on the detector on the basis of the incident wavelength. With this information, the calibration table corresponding to the measuring plane can then be used.
2. Time-shifted projection of illuminated light onto the various exhibition levels using appropriate lighting control. This means that the corresponding calibration table can be used for the evaluation based on the selected light source.
3. The expected measurement profiles remain in their own areas, which can be clearly distinguished with a monochrome sensor, so that a spatial ranking along the m-axis always remains constant during the measurement task. This requires that the images of two profiles on the detector must not intersect.

With regard to further advantageous embodiments of the de-vice according to the invention and the method according to the invention, reference is made to the general part of the description and to the appended claims in order to avoid repetition.

Finally, it should be expressly pointed out that the above-described embodiments of the device according to the invention and of the method according to the invention serve only to discuss the claimed method, but do not limit it to the embodiments.

### REFERENCE LIST

1 Illumination light
2, 2a, 2b Line light source
3, 3a, 3b Aperture
4 Deflection element
5 First range (measurement lens)
6 Measurement lens
7 Optical lens
8 Optical lens
9 Measurement object
10 Measuring light
11 second area (measurement lens)
12 Converter optic
13, 13a, 13b Entry aperture
14 Spectrometer
15 Lens
16 Lens
17 Deflection element
18 Directional aperture
19 Optical lens
20 Optical lens
21
22 Area detector
23 Dyson lens
24 Line grid
25
26 Optical axis (measurement lens)
26a Virtual optical axis
27 Distance axis
28, 28a, 28b Measuring plane
29 Wavelength 1
30 Wavelength 2
31 Wavelength 3
32, 32a, 32b m=f (z, x, y) with x, y=const.
33, 33a, 33b Color-coded profile
34, 34a, 34b Spectral range
m Line area detector
n Column area detector
X Position along line
y Lateral position of the projection plane
Z Distance measuring point from measurement lens

1. System for confocal chromatic line distance measurement, having a line light source, an aperture, a confocal-chromatic, measurement lens, and a spectrometer, wherein the illumination beam path extends from the light source via the aperture and a first region of the measurement lens to the measurement object and wherein the imaging beam path extends from the measurement object via a second region of the measurement lens to the spectrometer.

2. System according to claim 1, characterized in that the aperture, the measurement lens, and an entrance aperture of the spectrometer lie on a common virtual optical axis.

3. System according to claim 1, characterized in that the measurement lens has exactly one optical lens or in that the measurement lens has at least two optical lenses, the lenses of the measurement lens being arranged concentrically to one another.

4. System according to claim 1, characterized in that a single confocal-chromatic measurement lens is arranged.

5. System according to claim 1, characterized in that the optical axis of the measurement lens coincides with the distance axis of the system.

6. System according to claim 1, characterized in that the line light source emits a continuous white light line.

7. System according to claim 1, characterized in that the line light source emits two or more, illumination lines as illumination light and/or in that two or more line light sources are arranged which each emit at least one, illumination line as illumination light.

8. System according to claim 1, characterized in that the line light source is arranged on the entrance side in the focal point of the measurement lens.

9. System according to claim 1, characterized in that a deflection element is arranged in the illumination beam path and/or in the imaging beam path, with the deflection element serving as a directional aperture and blinding the illumination light in such a way that the illumination light only strikes the measurement lens in the first area.

10. System according to claim 9, characterized in that the deflection element is designed as a mirror or as a beam splitter.

11. System according to claim 9, characterized in that a deflection element is arranged in the illumination beam path between the aperture and the measurement lens and/or in that a deflection element is arranged in the imaging beam path between the measurement lens and the spectrometer.

12. System according to claim 1, characterized in that a converter optic is arranged.

13. System according to claim 12, characterized in that the converter optic is arranged in the imaging beam path between the measurement lens and the spectrometer or in the illumination beam path between the light source and the measurement lens.

14. System according to claim 12, characterized in that the converter optic has at least one optical lens, the at least one optical lens being arranged concentrically to the measurement lens in a basic optical model and/or lying with the measurement lens on the common virtual optical axis.

15. System according to claim 1, characterized in that the spectrometer is a Dyson spectrometer.

16. System according to claim 1, characterized in that the spectrometer has an, in particular slit-shaped, entrance aperture, an optical lens, in particular a Dyson lens, a, in particular concave, line grid and an area detector.

17. System according to claim 16, characterized in that the line grid is provided with a blaze structure and/or has equidistant, parallel structures.

18. System according to claim 16, characterized in that the entrance aperture has a width of less than or equal to 20 μm, preferably less than or equal to 10 μm.

19. System according to claim 1, characterized in that the illumination beam path and the imaging beam path between the measurement lens and the measurement object each extend at an angle in the range from 45° to 90°, in particular from 60° to 90°, preferably from 80° to 90°, relative to one another.

20. Method for confocal-chromatic line distance measurement, preferably using a system according to claim 1, wherein illumination light is directed from a line light source via an aperture and a first region of a confocal-chromatic measurement lens as a color-coded illumination plane onto a measurement object, wherein spectrally coded measuring light is guided from the measurement object via a second region of the measurement lens to a spectrometer, and wherein a spectrometric analysis of the measuring light is performed to determine the distance.
